(19) United States
(12) Patent Application Publication
(10) Pub. No.: US 2016/0205032 A1
(43) Pub. Date: Jul. 14, 2016

(54) SYSTEM AND METHOD FOR MULTI-SCREEN ONBOARDING AND INTERACTION

(71) Applicant: 3doo, Inc., New York, NY (US)

(72) Inventor: Ingo Nadler, Bad Breisig (DE)

(73) Assignee: 3doo, Inc., New York, NY (US)

(21) Appl. No.: 14/596,720

(22) Filed: Jan. 14, 2015

(51) Int. Cl. H04L 12/911; G06F 3/0484

(52) U.S. Cl. CPC H04L 47/70; G06F 3/04842

(57) ABSTRACT

A method for performing multi-screen onboarding is presented including associating a first application with a first electronic device, associating a second application with a second electronic device, the second electronic device being in communication with the first electronic device, and associating a third application with one or more servers. The method further includes the steps of enabling a user to input information into the second electronic device via the second application and enabling the user to access content of the second electronic device on display hardware of the first electronic device, the content sent to the first electronic device via the one or more servers.

### BACKGROUND

1. Technical Field

The present disclosure relates to onboarding and identity management systems. More particularly, the present disclosure relates to a system and method for performing multi-screen onboarding and interaction between one or more electronic devices.

2. Description of Related Art

Identity management is often regarded as the management of information (as held in a directory) that represents items identified in real life (e.g., users, organizations, devices, services, etc.). The management of identities is often associated with the management of user credentials and the processes and means by which users might log on to an online system and connect to selected system resources. Identity management systems or subsystems are used in information systems to support the management of identities. For example, a general purpose identity management system may be used to manage user identities and their respective security entitlements in an identity profile to selectively control access to a heterogeneous set of resources such as applications. One aspect of using an identity management system includes “onboarding” a new resource, such as adding a new application for users to access. In this instance, the identity management system configures the identities and user entitlements of the resource. However, there is very little standardization of identity profiles required by the resources. Each resource often requires a different identity profile, and the native identity and access attributes used by the resource may need to be mapped to identity and access attributes in the identity management system.

Therefore, what is needed is a method and system for providing a common platform for onboarding a plurality of electronic devices without the need for a user to create separate profiles on each of the plurality of electronic devices.

### SUMMARY

Embodiments of the present disclosure are described in detail with reference to the drawing figures wherein like reference numerals identify similar or identical elements.

An aspect of the present disclosure provides a method for performing multi-screen onboarding. The method includes the steps of associating a first application with a first electronic device; associating a second application with a second electronic device, the second electronic device being in communication with the first electronic device; associating a third application with one or more servers; enabling a user to input information into the second electronic device via the second application; and enabling the user to access content of the second electronic device on display hardware of the first electronic device, the content sent to the first electronic device via the one or more servers.

In one aspect, the first electronic device is a television and the second electronic device is a mobile device.

In another aspect, the method further comprises generating a unique time stamped identification code for the first electronic device to link the first electronic device onboarding process with the second electronic device.

In yet another aspect, the method further comprises determining whether the first electronic device is associated with an account on the second electronic device. If the first electronic device is not associated with the account on the second electronic device, the user is prompted to enter a first electronic device onboarding identification code into the second electronic device.

In one aspect, the first electronic device onboarding identification code is sent to the one or more servers. The one or more servers verify whether the first electronic device onboarding identification code is valid. Upon validation, the first electronic device onboarding identification code is associated with the account on the second electronic device.

In another aspect, the first application serves as an agent to display the content of the second electronic device on the display hardware of the first electronic device.

In yet another aspect, the second application serves to provide a user interface for content selection made by the user of the second electronic device.

Another aspect of the present disclosure provides a system for performing multi-screen onboarding. The system includes a first electronic device having a first application; a second electronic device having a second application, the first electronic device being in communication the first electronic device; one or more servers having a third application; and a network connected to the one or more servers; wherein a user inputs information into the second electronic device via the second application so that the user accesses content of the second electronic device on display hardware of the first electronic device, the content sent to the first electronic device via the one or more servers.

Certain embodiments of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

### BRIEF DESCRIPTION OF THE DRAWING

Various embodiments of the present disclosure are described herein below with references to the drawings, wherein:

FIG. 1 is a flowchart illustrating an onboarding process, in accordance with embodiments of the present disclosure;

FIG. 2 is a flowchart illustrating a playback process, in accordance with embodiments of the present disclosure;

FIG. 3 is a system illustrating an onboarding process for one electronic device associated with the mobile device, in accordance with embodiments of the present disclosure; and

FIG. 4 is a system illustrating an onboarding process for a plurality of electronic devices associated with the mobile device, in accordance with embodiments of the present disclosure.

The figures depict embodiments of the present disclosure for purposes of illustration only. One skilled in the art will readily recognize from the following disclosure that alternative embodiments of the structures and methods illustrated herein may be employed without departing from the principles of the present disclosure described herein.

### DETAILED DESCRIPTION

Although the present disclosure will be described in terms of specific embodiments, it will be readily apparent to those skilled in this art that various modifications, rearrangements and substitutions may be made without departing from the spirit of the present disclosure. The scope of the present disclosure is defined by the claims appended hereto.

For the purposes of promoting an understanding of the principles of the present disclosure, reference will now be made to the exemplary embodiments illustrated in the drawings, and specific language will be used to describe the same. It will nevertheless be understood that no limitation of the scope of the present disclosure is thereby intended. Any alterations and further modifications of the inventive features illustrated herein, and any additional applications of the principles of the present disclosure as illustrated herein, which would occur to one skilled in the relevant art and having possession of this disclosure, are to be considered within the scope of the present disclosure.

The word “exemplary” is used herein to mean “serving as an example, instance, or illustration.” Any embodiment described herein as “exemplary” is not necessarily to be construed as preferred or advantageous over other embodiments. The word “example” may be used interchangeably with the term “exemplary.”

The term “electronic device” may refer to one or more personal computers (PCs), a standalone printer, a standalone scanner, a mobile phone, an MP3 player, gaming consoles, audio electronics, video electronics, GPS systems, televisions, recording and/or reproducing media (such as CDs, DVDs, camcorders, cameras, etc.) or any other type of consumer or non-consumer analog and/or digital electronics. Such consumer and/or non-consumer electronics may apply in any type of entertainment, communications, home, and/or office capacity. Thus, the term “electronic device” may refer to any type of electronics suitable for use with a circuit board and intended to be used by a plurality of individuals for a variety of purposes. The electronic device may be any type of computing and/or processing device.

The term “processing” may refer to determining the elements or essential features or functions or processes of one or more 3D and/or onboarding systems for computational processing. The term “process” may further refer to tracking data and/or collecting data and/or manipulating data and/or examining data and/or updating data on a real-time basis in an automatic manner and/or a selective manner and/or manual manner.

The term “storage” may refer to data storage. “Data storage” may refer to any article or material (e.g., a hard disk) from which information may be capable of being reproduced, with or without the aid of any other article or device. “Data storage” may refer to the holding of data in an electromagnetic form for access by a computer processor. Primary storage may be data in random access memory (RAM) and other “built-in” devices. Secondary storage may be data on hard disk, tapes, and other external devices. “Data storage” may also refer to the permanent holding place for digital data, until purposely erased. “Storage” implies a repository that retains its content without power. “Storage” mostly means magnetic disks, magnetic tapes and optical discs (CD, DVD, etc.). “Storage” may also refer to non-volatile memory chips such as flash, Read-Only memory (ROM) and/or Electrically Erasable Programmable Read-Only Memory (EEPROM).

The term “module” or “unit” may refer to a self-contained component (unit or item) that may be used in combination with other components and/or a separate and distinct unit of hardware or software that may be used as a component in a system, such as a 3D and/or onboarding system. The term “module” may also refer to a self-contained assembly of electronic components and circuitry, such as a stage in a computer that may be installed as a unit. The term “module” may be used interchangeably with the term “unit.”

Reference will now be made in detail to embodiments of the present disclosure. While certain embodiments of the present disclosure will be described, it will be understood that it is not intended to limit the embodiments of the present disclosure to those described embodiments. To the contrary, reference to embodiments of the present disclosure is intended to cover alternatives, modifications, and equivalents as may be included within the spirit and scope of the embodiments of the present disclosure as defined by the appended claims.

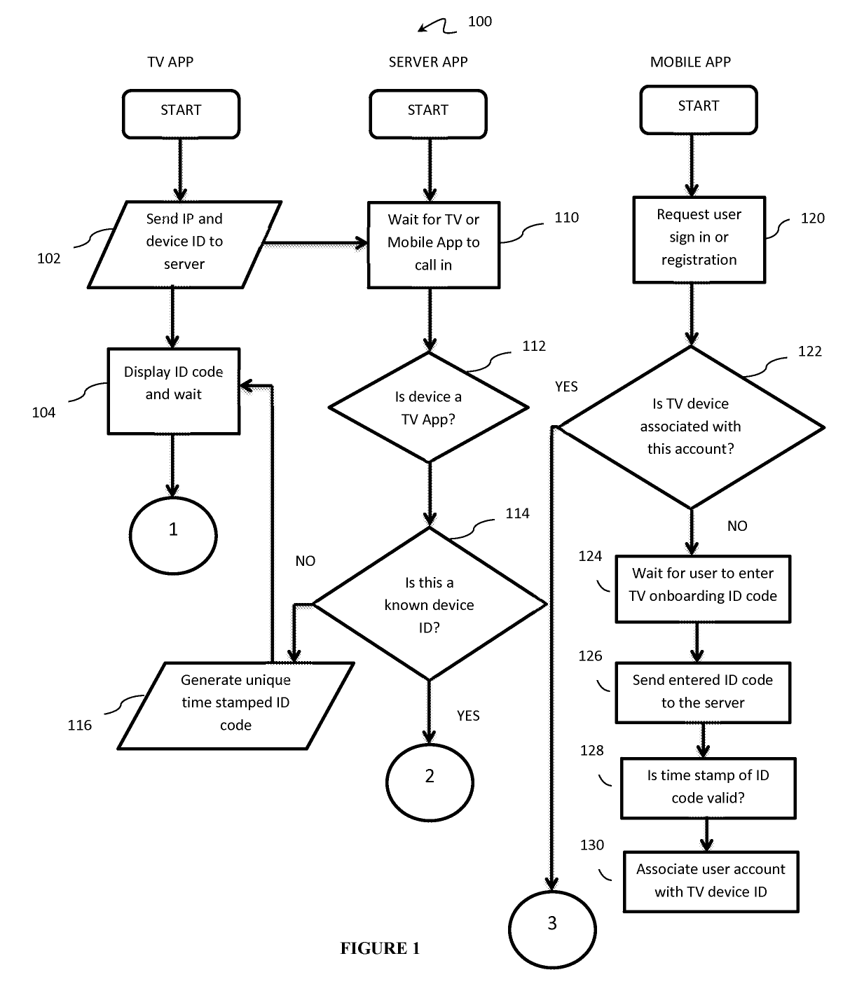

FIG. 1 a flowchart illustrating an onboarding process, in accordance with embodiments of the present disclosure.

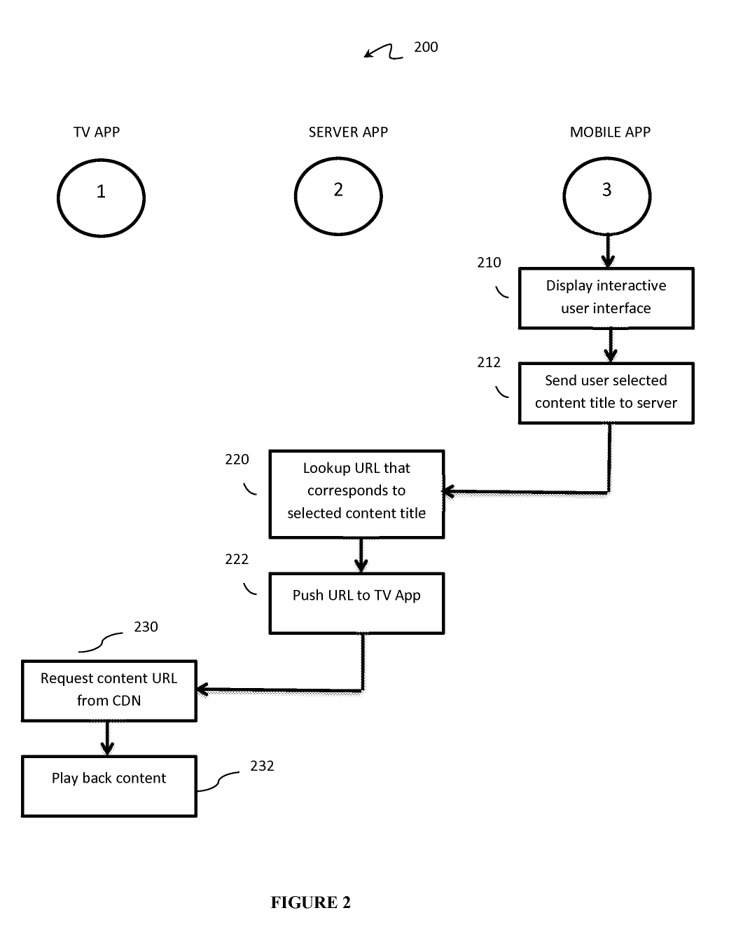

The flowchart 100 includes the following steps. In step 102, the TV application sends its device ID or ID code to the server. In step 104, the ID code is displayed and the TV waits for further instructions. In step 110, the server application waits for either the TV application or the mobile application to call in. In step 112, the server determines whether the device contacting the server is the TV (or TV application). In step 114, if YES, it is determined whether the TV application is a known device ID or ID code. If YES, the process proceeds to the playback process of FIG. 2. In step 120, the mobile application receives a request from a user to sign in or register. In step 122, it is determined whether the TV device is associated with the account of the mobile application of the mobile device. If YES, the process proceeds to the playback process of FIG. 2. If NO, the process proceeds to step 124. In step 124, the mobile device application of the mobile device waits for the user to enter the TV onboarding code or ID code. In step 126, the entered TV ID code is sent to the server. In step 128, the server determines whether the time stamp of the TV ID code is valid. In step 130, if validation is confirmed, the user account of the mobile application of the mobile device is associated with the TV device ID. The process then ends.

It is to be understood that the method steps described herein need not necessarily be performed in the order as described. Further, words such as “thereafter,” “then,” “next,” etc., are not intended to limit the order of the steps. These words are simply used to guide the reader through the description of the method steps.

FIG. 2 is a flowchart illustrating a playback process, in accordance with embodiments of the present disclosure.

The flowchart 200 includes the following steps. In step 210, the mobile application of the mobile device displays an interactive user interface. In step 212, the user selects desired content, the request being sent to the server. In step 220, the server application of the server looks up the URL that corresponds to the selected content. In step 222, the URL is sent to the TV application of the TV. In step 230, the TV application of the TV requests the URL with the content from the content delivery network (CDN). In this case, the CDN is the one or more servers providing communication between the mobile device and the television. In step 232, the TV plays back the content received from the mobile device. The process then ends.

It is to be understood that the method steps described herein need not necessarily be performed in the order as described. Further, words such as “thereafter,” “then,” “next,” etc., are not intended to limit the order of the steps. These words are simply used to guide the reader through the description of the method steps.

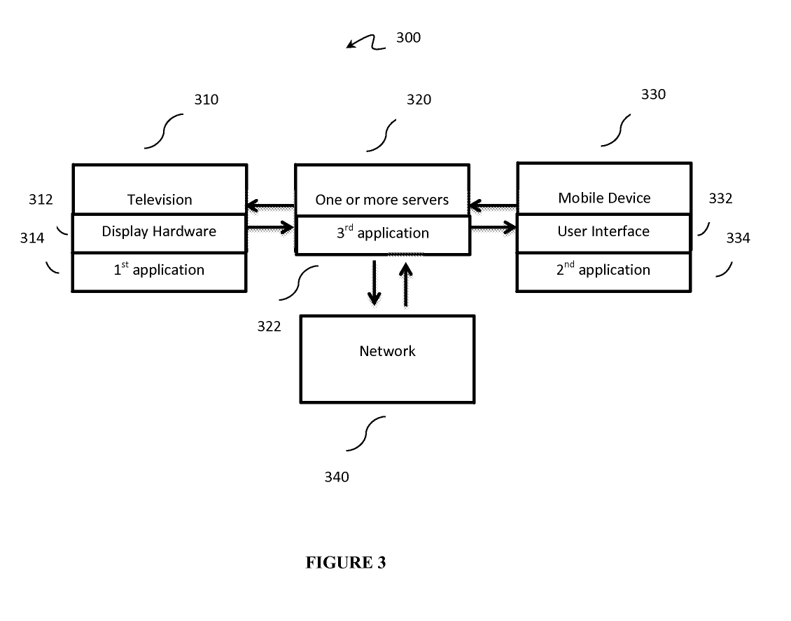

FIG. 3 is a system 300 illustrating an onboarding process for one electronic device associated with the mobile device, in accordance with embodiments of the present disclosure.

System 300 includes a first electronic device 310, which is a television in the instant case, one or more servers 320, and a second electronic device 330, which is a mobile device in the instant case. The first electronic device 310 includes display hardware 312 and a first application 314. The first application 314 is a TV application 314. The second electronic device 330 includes a user interface 332 and a second application 334. The second application 334 is a mobile device application 334. The one or more servers 320 include a 3^{rd} application 322. The one or more servers 320 are connected to at least one network 340. The network 340 may be, for example, the Internet.

Network 340 may be a group of interconnected (via cable and/or wireless) computers, databases, servers, routers, and/or peripherals that are capable of sharing software and hardware resources between many users. The Internet is a global network of networks. Network 340 may be a communications network. Thus, network 340 may be a system that enables users of data communications lines to exchange information over long distances by connecting with each other through a system of routers, servers, switches, databases, and the like.

Network 340 may include a plurality of communication channels. The communication channels refer either to a physical transmission medium such as a wire or to a logical connection over a multiplexed medium, such as a radio channel. A channel is used to convey an information signal, for example a digital bit stream, from one or several senders (or transmitters) to one or several receivers. A channel has a certain capacity for transmitting information, often measured by its bandwidth. Communicating data from one location to another requires some form of pathway or medium. These pathways, called communication channels, use two types of media: cable (twisted-pair wire, cable, and fiber-optic cable) and broadcast (microwave, satellite, radio, and infrared). Cable or wire line media use physical wires of cables to transmit data and information. The communication channels are part of network 340.

Moreover, the electronic devices 310, 330 may be any type of be computing devices, such as a wearable computing device, a smartphone, a smart watch, a gaming console, or a 3D television. Of course, one skilled in the art may contemplate any type of electronic device capable of streaming data/information, such as 3D data/information. The application 314 may be embedded within the first electronic device 310. However, one skilled in the art may contemplate the first application 314 to be separate and distinct from the first electronic device 310. The first application 314 may be remotely located with respect to the first electronic device 310. Similarly, one skilled in the art may contemplate the second application 334 to be separate and distinct from the second electronic device 330. The second application 334 may be remotely located with respect to the second electronic device 330.

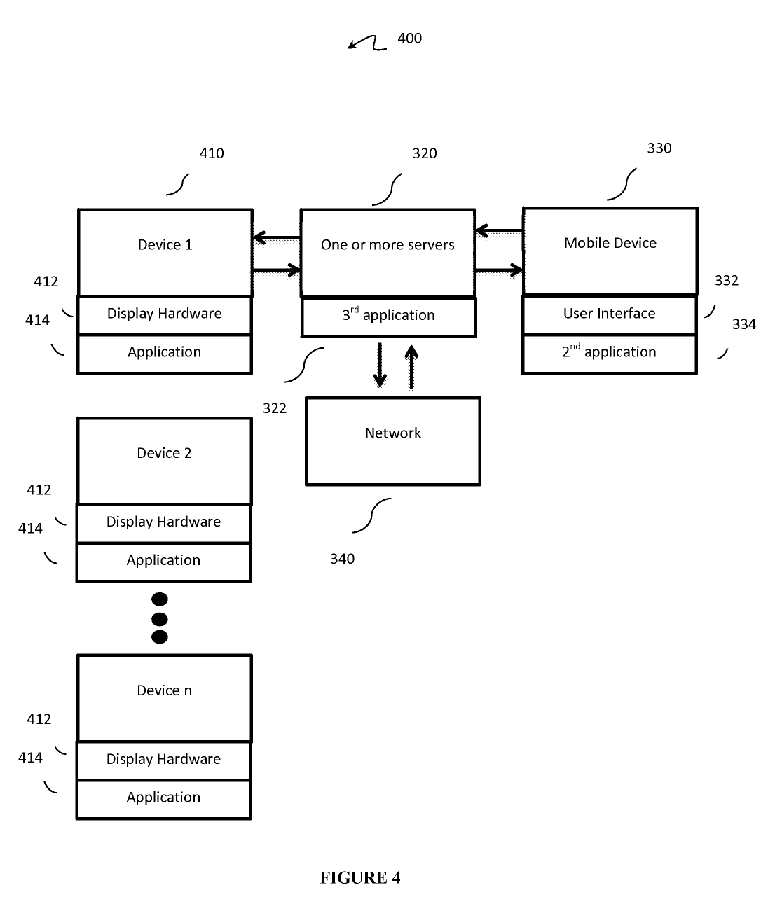

FIG. 4 is a system 400 illustrating an onboarding process for a plurality of electronic devices associated with the mobile device, in accordance with embodiments of the present disclosure.

Similar elements to FIG. 3 will not be described for sake of clarity. In contrast to FIG. 3, FIG. 4 illustrates a plurality of electronic devices associated with the mobile device 330. In particular, a plurality of electronic devices 410 each having display hardware 412 and applications 414 may be able to communicate with the single mobile device 330. Therefore, the content of the mobile device 330 may be transmitted, upon verification/authentication of ID codes, to one or more of the plurality of electronic devices 410.

In operation, a mobile device 330 of a user has a mobile device application 334. The mobile device application 334 allows the user to access a user interface 332 in order to access content found on the mobile device 330. The content is not displayed on the mobile device 330. Instead, the content of the mobile device 330 is sent to a server application 322 located on one or more servers 320. The one or more servers 320 determine whether a television 310 is associated with an account of the mobile device 330. Once authorization has been established or confirmed, the one or more servers 320 transmit the content of the mobile device 330 to the TV application 314 of the TV 310. The display means 312 of the TV 310 displays the content of the mobile device 330. Thus, the user can view the content of the mobile device 330 on the TV 310 without the need to create separate and distinct profiles on each electronic device (e.g., mobile device, television). Therefore, the user need only create one profile with one electronic device to access the content of such electronic device on a plurality of other electronic devices. Such access is permitted as long as one or more servers can verify that the account of the mobile device 330 can be associated with the television 310 or a plurality of other electronic devices. One skilled in the art may contemplate a plurality of electronic devices capable of being associated with the account of the mobile device 330.

In summary, the exemplary embodiments of the present disclosure simplify the registration process or the “onboarding” process by providing a unique method of accessing content to view, interacting within the onboarding platform, and displaying the desired content to view on another electronic device, such as a television, without requiring a connection for streaming data/information/video/images between the television 310 and the mobile device 330. Instead, the exemplary embodiments of the present disclosure provide for a television application 314 of a television 310 to serve as an agent to display the desired content of the mobile device 330 on the display hardware 312 of the television 310, while providing all the interactive elements, such as the user interface 334 for content selection on the mobile application 334 of the mobile device 330. Therefore, the onboarding of the user is always completed by the mobile device 330 that allows for faster entry of characters and is linked to the television 310 via a time stamped code. All three applications 314, 322, 334 are connected via the network 340.

Consequently, a user need only create one user account or one user profile with one electronic device (e.g., a mobile device). The user may then view the content accessed via the mobile device on a plurality of other electronic devices (e.g., one or more televisions). The content to be viewed via the television from the mobile device passes through one or more servers, which verify whether a relationship exists between the plurality of electronic devices and the mobile device including the content desired to be viewed on the plurality of electronic devices. The user can enter one or more onboarding codes to be verified and/or authenticated by the one or more servers. Once authenticated/verified, the one or more of the plurality of electronic devices that are indeed associated with the account of the mobile device, receive the desired content of the mobile device.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, tablets, portable/personal digital assistants, and other devices that facilitate communication of information between end-users within a network.

The general features and aspects of the present disclosure remain generally consistent regardless of the particular purpose. Further, the features and aspects of the present disclosure may be implemented in system in any suitable fashion, e.g., via the hardware and software configuration of system or using any other suitable software, firmware, and/or hardware.

For instance, when implemented via executable instructions, various elements of the present disclosure are in essence the code defining the operations of such various elements. The executable instructions or code may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, readable media may include any medium that may store or transfer information.

The computer means or computing means or processing means may be operatively associated with the stereoscopic system, and is directed by software to compare the first output signal with a first control image and the second output signal with a second control image. The software further directs the computer to produce diagnostic output. Further, a means for transmitting the diagnostic output to an operator of the verification device is included. Thus, many applications of the present disclosure could be formulated. The exemplary network disclosed herein may include any system for exchanging data or transacting business, such as the Internet, an intranet, an extranet, WAN (wide area network), LAN (local area network), satellite communications, and/or the like. It is noted that the network may be implemented as other types of networks.

Additionally, “code” as used herein, or “program” as used herein, may be any plurality of binary values or any executable, interpreted or compiled code which may be used by a computer or execution device to perform a task. This code or program may be written in any one of several known computer languages. A “computer,” as used herein, may mean any device which stores, processes, routes, manipulates, or performs like operation on data. A “computer” may be incorporated within one or more transponder recognition and collection systems or servers to operate one or more processors to run the transponder recognition algorithms. Moreover, computer-executable instructions include, for example, instructions and data which cause a general purpose computer, special purpose computer, or special purpose processing device to perform a certain function or group of functions. Computer-executable instructions also include program modules that may be executed by computers in stand-alone or network environments. Generally, program modules include routines, programs, objects, components, and data structures, etc., that perform particular tasks or implement particular abstract data types.

Persons skilled in the art will understand that the devices and methods specifically described herein and illustrated in the accompanying drawings are non-limiting exemplary embodiments. The features illustrated or described in connection with one exemplary embodiment may be combined with the features of other embodiments. Such modifications and variations are intended to be included within the scope of the present disclosure.

The foregoing examples illustrate various aspects of the present disclosure and practice of the methods of the present disclosure. The examples are not intended to provide an exhaustive description of the many different embodiments of the present disclosure. Thus, although the foregoing present disclosure has been described in some detail by way of illustration and example for purposes of clarity and understanding, those of ordinary skill in the art will realize readily that many changes and modifications may be made thereto without departing form the spirit or scope of the present disclosure.

While several embodiments of the disclosure have been shown in the drawings and described in detail hereinabove, it is not intended that the disclosure be limited thereto, as it is intended that the disclosure be as broad in scope as the art will allow. Therefore, the above description and appended drawings should not be construed as limiting, but merely as exemplifications of particular embodiments. Those skilled in the art will envision other modifications within the scope and spirit of the claims appended hereto.

What is claimed is:

1. A method for performing multi-screen onboarding, the method comprising:
associating a first application with a first electronic device;
associating a second application with a second electronic device, the second electronic device being in communication with the first electronic device;
associating a third application with one or more servers;
enabling a user to input information into the second electronic device via the second application; and
enabling the user to access content of the second electronic device on display hardware of the first electronic device, the content sent to the first electronic device via the one or more servers.

2. The method of claim 1, wherein the first electronic device is a television and the second electronic device is a mobile device.

3. The method of claim 1, further comprising generating a unique time stamped identification code for the first electronic device to link the first electronic device onboarding process with the second electronic device.

4. The method of claim 1, further comprising determining whether the first electronic device is associated with an account on the second electronic device.

5. The method of claim 4, wherein, if the first electronic device is not associated with the account on the second electronic device, the user is prompted to enter a first electronic device onboarding identification code into the second electronic device.

6. The method of claim 5, wherein the first electronic device onboarding identification code is sent to the one or more servers.

7. The method of claim 6, wherein the one or more servers verify whether the first electronic device onboarding identification code is valid.

8. The method of claim 7, wherein, upon validation, the first electronic device onboarding identification code is associated with the account on the second electronic device.

9. The method of claim 1, wherein the first application serves as an agent to display the content of the second electronic device on the display hardware of the first electronic device.

10. The method of claim 1, wherein the second application serves to provide a user interface for content selection made by the user of the second electronic device.

11. A system for performing multi-screen onboarding, the system comprising:
a first electronic device having a first application;
a second electronic device having a second application, the first electronic device being in communication the first electronic device;
one or more servers having a third application; and
a network connected to the one or more servers;
wherein a user inputs information into the second electronic device via the second application so that the user accesses content of the second electronic device on display hardware of the first electronic device, the content sent to the first electronic device via the one or more servers.

12. The system of claim 11, wherein the first electronic device is a television and the second electronic device is a mobile device.

13. The system of claim 11, wherein a unique time stamped identification code for the first electronic device is generated to link the first electronic device onboarding process with the second electronic device.

14. The system of claim 11, wherein it is determined whether the first electronic device is associated with an account on the second electronic device.

15. The system of claim 14, wherein, if the first electronic device is not associated with the account on the second electronic device, the user is prompted to enter a first electronic device onboarding identification code into the second electronic device.

16. The system of claim 15, wherein the first electronic device onboarding identification code is sent to the one or more servers.

17. The system of claim 16, wherein the one or more servers verify whether the first electronic device onboarding identification code is valid.

18. The system of claim 17, wherein, upon validation, the first electronic device onboarding identification code is associated with the account on the second electronic device.

19. The system of claim 11, wherein the first application serves as an agent to display the content of the second electronic device on the display hardware of the first electronic device.

20. The system of claim 11, wherein the second application serves to provide a user interface for content selection made by the user of the second electronic device.
